(19) United States
(12) Patent Application Publication
(10) Pub. No.: US 2026/0278270 A1
(43) Pub. Date: Sep. 17, 2026

(54) CORRECTION DEVICE, CORRECTION METHOD, AND RECORDING MEDIUM

(71) Applicant: NEC Corporation, Tokyo (JP)

(72) Inventor: Tsukasa SAITO, Tokyo (JP)

(73) Assignee: NEC Corporation, Tokyo (JP)

(21) Appl. No.: 19/556,089

(22) Filed: Mar. 4, 2026

(30) Foreign Application Priority Data
Mar. 14, 2025 (JP) 2025-041769

(51) Int. Cl. G06F 40/232; G06F 40/268

(52) U.S. Cl. CPC G06F 40/232; G06F 40/268

(57) ABSTRACT

A correction device performs position estimation of an erroneous word in a speech text obtained by speech recognition, classifies a candidate word into one of the classes including a correction word class that is a class indicating that the candidate word is a candidate to be replaced from the erroneous word and an unknown term class that is a class indicating a possibility that there is no candidate word to be replaced from the erroneous word by using a prediction score for each candidate word to be replaced from the erroneous word and a phonological similarity score with the erroneous word for each candidate word, determines, based on a classification result of the candidate word, whether to replace the erroneous word with the candidate word or replace the erroneous word with reading of the erroneous word, and corrects the speech text according to the determination.

### CROSS REFERENCE TO THE RELATED APPLICATION

This application is based upon and claims the benefit of priority from Japanese Patent Application No. 2025-041769, filed on Mar. 14, 2025, the disclosure of which is incorporated herein in its entirety by reference.

### TECHNICAL FIELD

The present disclosure relates to a correction device, a correction method, and a recording medium.

### BACKGROUND ART

From the speech text of the speech recognition result, a recognition error of a word that is not registered in the speech recognition dictionary may be detected as a recognition error of an unknown term.

For example, JP 2017-187541 A describes extracting a similar phoneme string as a candidate of an unknown term by focusing on repetitive utterance of the unknown term, and detecting and registering a candidate that is not a known word among the candidates of the unknown term as the unknown term.

### SUMMARY

In order to efficiently detect a speech recognition error, it is preferable to perform processing of detecting a recognition error of a word that is not registered in the dictionary and processing of detecting a recognition error of a word that is registered in the dictionary as one processing combining both processing.

An object of the present disclosure is to provide a correction device, a correction method, and a program that can solve the above-described problems.

According to a first aspect of the present disclosure, a correction device includes a position estimation means for estimating presence or absence of an erroneous word that is a portion having a possibility of an error in a speech text obtained by speech recognition, and a position of the erroneous word in a case where it is estimated that there is the erroneous word, a candidate character generation means for generating a candidate word that is a candidate for a word to be replaced from the erroneous word, and calculating a prediction score indicating validity in context for each generated candidate word, a phonological similar expression calculation means for calculating a phonological similarity score indicating a phonological similarity with the erroneous word for each candidate word, a classification means for classifying the candidate word into one of the classes including a correction word class that is a class indicating that the candidate word is a candidate to be replaced from the erroneous word and an unknown term class that is a class indicating a possibility that there is no candidate word to be replaced from the erroneous word by using the prediction score and the phonological similarity score, and a correction means for determining, based on a classification result of the candidate word, whether to replace the erroneous word with the candidate word or replace the erroneous word with reading of the erroneous word, and correcting the speech text according to the determination.

According to a second aspect of the present disclosure, a correction method includes, by a computer, estimating presence or absence of an erroneous word that is a portion having a possibility of an error in a speech text obtained by speech recognition, and a position of an erroneous word in a case where it is estimated that there is an erroneous word, generating a candidate word that is a candidate for a word to be replaced from the erroneous word, and calculating a prediction score indicating validity in context for each generated candidate word, calculating a phonological similarity score indicating a phonological similarity with the erroneous word for each candidate word, classifying the candidate word into one of the classes including a correction word class that is a class indicating that the candidate word is a candidate to be replaced from the erroneous word and an unknown term class that is a class indicating a possibility that there is no candidate word to be replaced from the erroneous word by using the prediction score and the phonological similarity score, and determining, based on a classification result of the candidate word, whether to replace the erroneous word with the candidate word or replace the erroneous word with reading of the erroneous word, and correcting the speech text according to the determination.

According to a third aspect of the present disclosure, a program causes a computer to execute estimating presence or absence of an erroneous word that is a portion having a possibility of an error in a speech text obtained by speech recognition, and a position of an erroneous word in a case where it is estimated that there is an erroneous word, generating a candidate word that is a candidate for a word to be replaced from the erroneous word, and calculating a prediction score indicating validity in context for each generated candidate word, calculating a phonological similarity score indicating a phonological similarity with the erroneous word for each candidate word, classifying the candidate word into one of the classes including a correction word class that is a class indicating that the candidate word is a candidate to be replaced from the erroneous word and an unknown term class that is a class indicating a possibility that there is no candidate word to be replaced from the erroneous word by using the prediction score and the phonological similarity score, and determining, based on a classification result of the candidate word, whether to replace the erroneous word with the candidate word or replace the erroneous word with reading of the erroneous word, and correcting the speech text according to the determination.

### BRIEF DESCRIPTION OF THE DRAWINGS

FIG. 1 is a diagram illustrating an example of a configuration of a correction device according to at least one example embodiment;

FIG. 2 is a diagram illustrating an example of a flow of processing in the correction device according to at least one example embodiment;

FIG. 3 is a diagram illustrating an example of a text to be corrected by the correction device according to at least one example embodiment;

FIG. 4 is a diagram illustrating a first example of position estimation of an erroneous word by a position estimation unit according to at least one example embodiment;

FIG. 5 is a diagram illustrating a second example of position estimation of an erroneous word by the position estimation unit according to at least one example embodiment;

FIG. 6 is a diagram illustrating a third example of position estimation of an erroneous word by the position estimation unit according to at least one example embodiment;

FIG. 7 is a diagram illustrating a first example of masking by a candidate character generation unit according to at least one example embodiment;

FIG. 8 is a diagram illustrating a second example of masking by the candidate character generation unit according to at least one example embodiment;

FIG. 9 is a diagram illustrating an example of giving reading to a candidate word by a phonological similar expression calculation unit according to at least one example embodiment;

FIG. 10 is a diagram illustrating an example of a processing procedure of classification of candidate words by a classification unit according to at least one example embodiment;

FIG. 11 is a diagram illustrating a first example of classification of candidate words by the classification unit according to at least one example embodiment;

FIG. 12 is a diagram illustrating a second example of classification of candidate words by the classification unit according to at least one example embodiment;

FIG. 13 is a diagram illustrating a third example of classification of candidate words by the classification unit according to at least one example embodiment;

FIG. 14 is a diagram illustrating an example of a display of a text before correction by a display unit according to at least one example embodiment;

FIG. 15 is a diagram illustrating an example of a display of a text after correction by the display unit according to at least one example embodiment;

FIG. 16 is a diagram illustrating a first example of processing performed by a user correction processing unit according to at least one example embodiment;

FIG. 17 is a diagram illustrating a second example of processing performed by a user correction processing unit according to at least one example embodiment;

FIG. 18 is a diagram illustrating a third example of processing performed by a user correction processing unit according to at least one example embodiment;

FIG. 19 is a diagram illustrating an example of a data structure of dictionary information stored in a dictionary information storage unit according to at least one example embodiment;

FIG. 20 is a diagram illustrating an example of a structure of data stored in a correction sentence storage unit according to at least one example embodiment;

FIG. 21 is a diagram illustrating an example of a configuration of a correction device according to at least one example embodiment;

FIG. 22 is a diagram illustrating an example of a procedure of processing in a correction method according to at least one example embodiment; and

FIG. 23 is a diagram illustrating an example of a configuration of a computer according to at least one example embodiment.

### EXAMPLE EMBODIMENT

Hereinafter, example embodiments will be described with reference to the drawings.

### First Example Embodiment

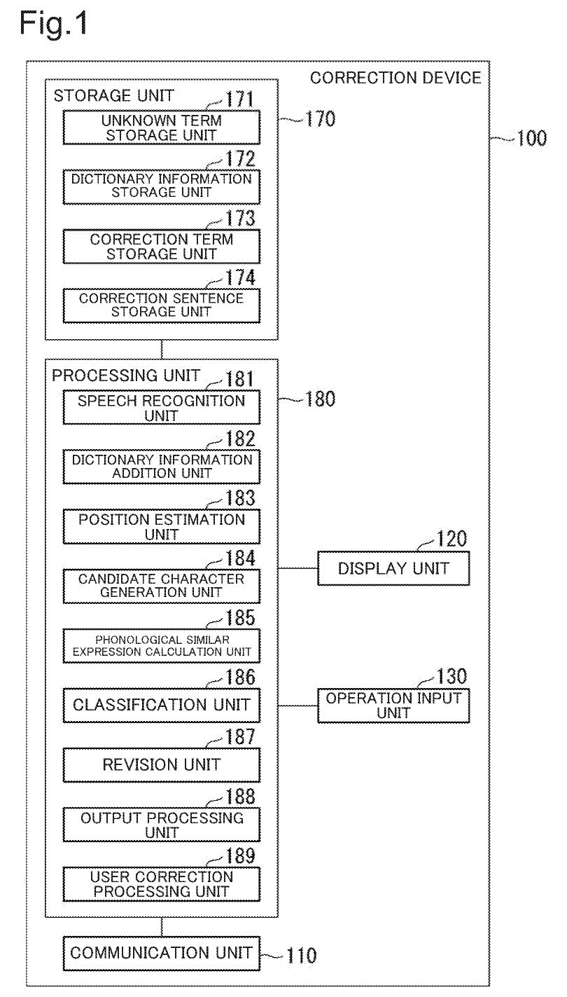

FIG. 1 is a diagram illustrating an example of a configuration of a correction device according to at least one example embodiment. In the configuration illustrated in FIG. 1, a correction device 100 includes a communication unit 110, a display unit 120, an operation input unit 130, a storage unit 170, and a processing unit 180.

The storage unit 170 includes an unknown term storage unit 171, a dictionary information storage unit 172, a correction term storage unit 173, and a correction sentence storage unit 174.

The processing unit 180 includes a speech recognition unit 181, a dictionary information addition unit 182, a position estimation unit 183, a candidate character generation unit 184, a phonological similar expression calculation unit 185, a classification unit 186, a revision unit 187, an output processing unit 188, and a user correction processing unit 189.

The correction device 100 corrects an error in speech recognition.

The correction device 100 may be configured using a computer, or may be configured using an Application Specific Integrated Circuit (ASIC) or a Field Programmable Gate Array (FPGA).

The communication unit 110 communicates with other devices. For example, the communication unit 110 may receive speech data from a device that records speech, such as an IC recorder.

The display unit 120 has a display screen such as a liquid crystal panel or a Light Emitting Diode (LED) panel, for example, and displays various images. For example, the display unit 120 may display the speech text corrected by the correction device 100 or the speech text being corrected by the correction device 100.

The speech text referred to here is a text (character string) of the speech recognition result. The speech text is also referred to as Automated Speech Recognition (ASR) output text.

The operation input unit 130 includes, for example, an input device such as a keyboard and a mouse, and accepts a user operation. For example, the operation input unit 130 may accept a user operation of correcting the speech text displayed on the display unit 120.

The storage unit 170 stores various types of data. The storage unit 170 is configured using a storage device included in the correction device 100.

The unknown term storage unit 171 stores a word determined to be an unknown term by the correction device 100. The unknown term referred to here is a word for which a language model used by the correction device 100 has not acquired distributed representation.

The dictionary information storage unit 172 stores dictionary information used by the correction device 100 to correct the speech text.

The correction term storage unit 173 stores a word determined as a correction term by the correction device 100. The correction term referred to here is a word to be used for correcting an error or a word used for correcting an error. The correction term is also referred to as a correction word.

The word referred to here is a word that is semantically divided into minimum units. In addition, a word configured by combining a plurality of words and treated as a group is also referred to as a compound word.

The correction sentence storage unit 174 stores the correction term, the speech text before being corrected using the correction term, and the speech text corrected using the correction term in association with each other. The data stored in the correction sentence storage unit 174 can be used as training data for training a speech recognition model used by the speech recognition unit 181. Training of the speech recognition model may also be referred to as Learning of the speech recognition model.

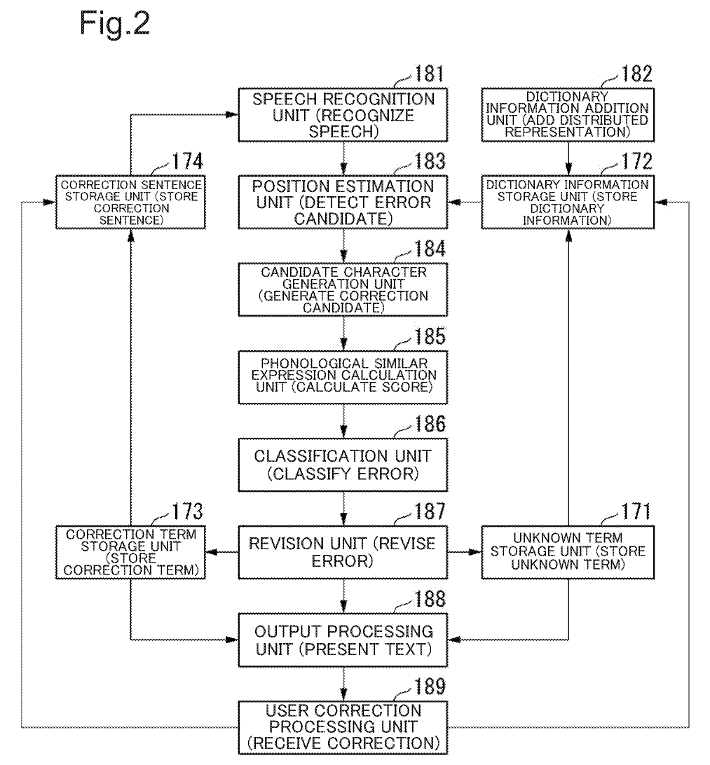

FIG. 2 is a diagram illustrating an example of a flow of processing in the correction device 100.

The speech recognition unit 181 performs speech recognition to generate a speech text. The speech recognition unit 181 may perform speech recognition using a known speech recognition method.

The speech recognition unit 181 outputs the speech text of the speech recognition result to the position estimation unit 183.

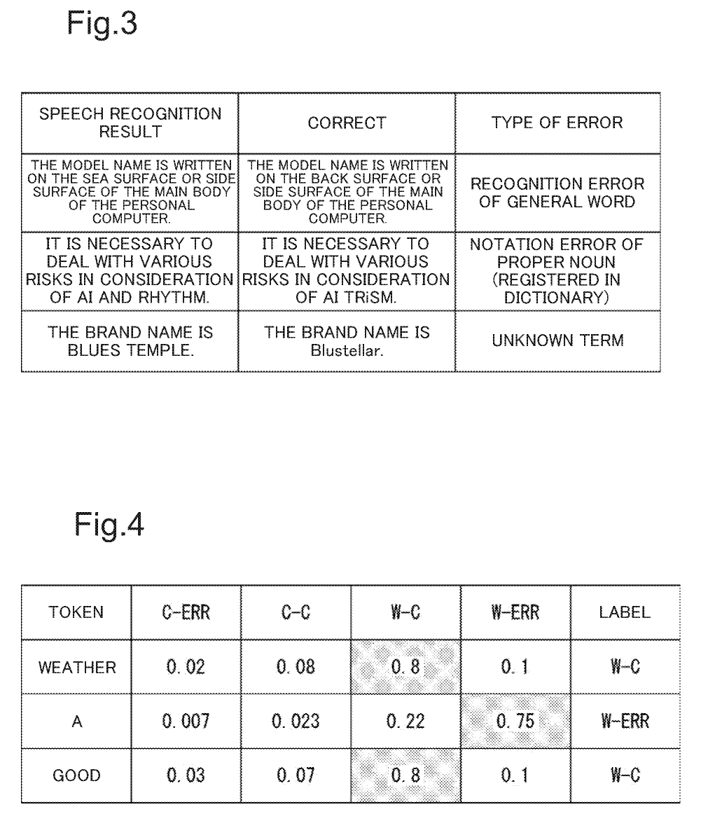

FIG. 3 is a diagram illustrating an example of a text to be corrected by the correction device 100. FIG. 3 illustrates an example of a case where an error is included in the speech text of the speech recognition result by the speech recognition unit 181.

In the example of FIG. 3, in the sentence “The model name is written on the sea surface or side surface of the main body of the personal computer.”, “sea surface” is an error, and to be correct, it is “back surface”. The correct “back surface” is a general word (a word other than a proper noun), and this error corresponds to a recognition error of the general word in speech recognition.

It is conceivable that the recognition error of the general word is caused by an external environmental factor at the time of speech recognition or a conversion error caused by the speech recognition model.

Furthermore, in the sentence “It is necessary to deal with various risks in consideration of AI and rhythm.”, “AI and rhythm” is an error, and to be correct, it is “AI TRiSM”. Here, it is assumed that “AI TRiSM” is a proper noun that has been acquired by the speech recognition model. This error corresponds to a notation error of a proper noun registered in the dictionary (registered in the speech recognition dictionary).

Similarly to the recognition error of the general word, it is conceivable that the notation error of the proper noun registered in the dictionary is also caused by an external environmental factor at the time of speech recognition or a conversion error caused by the speech recognition model.

Furthermore, in the sentence “The brand name is Blues temple.”, “Blues temple” is an error, and to be correct, it is “BluStellar”. Here, it is assumed that “BluStellar” is a word that has not been acquired by the speech recognition model. This error corresponds to an error due to an unknown term.

It is considered that the unknown term is caused by a word (i.e., a new word for the speech recognition model) that is not registered in the speech recognition dictionary.

The dictionary information addition unit 182 acquires the distributed representation related to the word held by the dictionary information storage unit 172. The distributed representation referred to here is an index for calculating the semantic similarity of words and is represented by a vector.

Next, the dictionary information addition unit 182 uses the word information and the example sentences stored in the dictionary information storage unit 172 to acquire the distributed representation of the word. For example, the dictionary information addition unit 182 may acquire a distributed representation by machine learning using the example sentences stored in the dictionary information storage unit 172, or may acquire a distributed representation after registering word information in a natural language model or a dictionary included in a morphological analyzer.

The dictionary information addition unit 182 causes the dictionary information storage unit 172 to store the distributed representation in association with the original word.

However, the method by which the dictionary information addition unit 182 acquires the distributed representation of the word is not limited to a specific method. Since the natural language model that has acquired the same distributed representation in the position estimation unit 183 and the candidate character generation unit 184 is used, it is preferable that the dictionary information addition unit 182 acquires the distributed representation by learning of the natural language model.

The position estimation unit 183 performs position estimation of an erroneous word. The erroneous word referred to here is an error word in the speech text.

The position estimation unit 183 corresponds to an example of a position estimation means.

FIG. 4 is a diagram illustrating a first example of the position estimation of an erroneous word by the position estimation unit 183. FIG. 4 illustrates an example of a case where the position estimation unit 183 performs position estimation of an erroneous word of a text “good a weather”. It is assumed that the position estimation unit 183 divides this text like “good/a/weather”.

In the example of FIG. 4, the position estimation unit 183 calculates each score of C-ERR, C-C, W-C, and W-ERR for each token included in the text. The token may be a minimum unit having a meaning (a minimum unit obtained by semantically dividing the text) or a group larger than the minimum unit. One word may correspond to one token.

Then, the position estimation unit 183 labels the token based on the calculated score.

C-ERR (Compound-Error) is an error in a compound word.

C-C (Compound-Correct) means that the compound word is correct.

W-C (word-correct) means that the token is correct in units of words.

W-ERR (word-Error) means that the token is wrong in units of words.

In the example of FIG. 4, the position estimation unit 183 calculates, as each score of C-ERR, C-C, W-C, and W-ERR, a score indicating that the larger the value, the higher the applicable degree, such as, for example, probability. The position estimation unit 183 may calculate each score of C-ERR, C-C, W-C, and W-ERR using a known method.

The score calculated by the position estimation unit 183 is not limited to a specific score and can be various scores that can perform error estimation in the text. On the other hand, the position estimation unit 183 can estimate both the error of the word and the error of the compound word by calculating the scores of both the compound word and the word.

In the example of FIG. 4, for “weather”, the score of W-C is the largest at 0.8, and the position estimation unit 183 labels it with W-C. For “a”, the score 0.75 of W-ERR is the largest at 0.75, and the position estimation unit 183 labels it with W-ERR. For “good”, the score of W-C is the largest at 0.8, and the position estimation unit 183 labels it with W-C.

As a result, the position estimation unit 183 estimates that “a” is an erroneous word. Then, the position estimation unit 183 calculates the score 0.75 of W-ERR of “a” that is a score estimated as an erroneous word as an error score.

The error score is a score indicating a high possibility that a word detected as an erroneous word is actually an error.

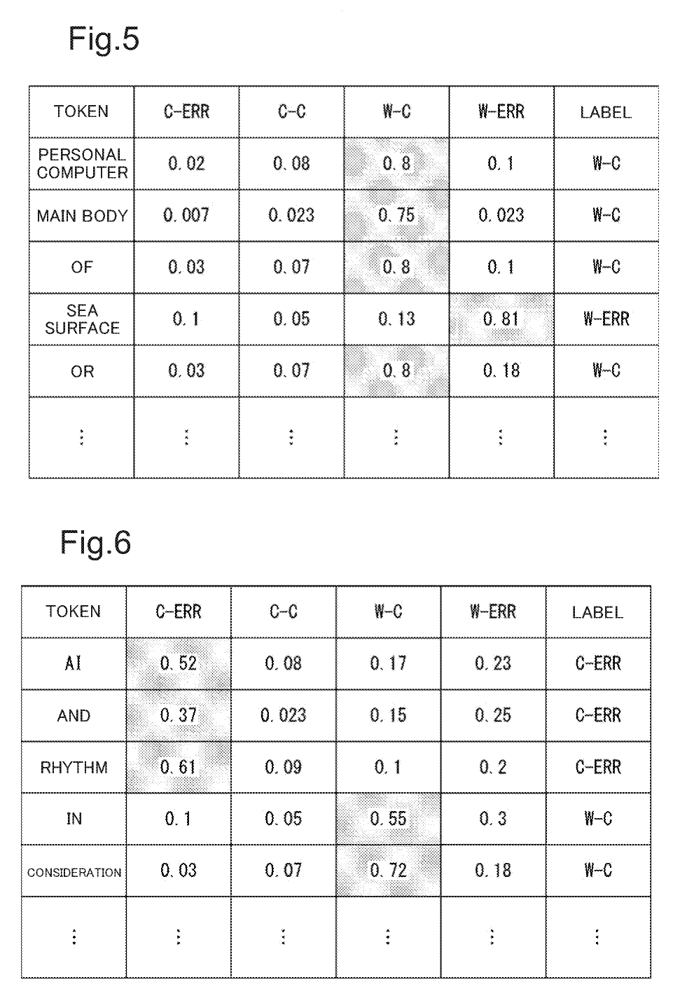

FIG. 5 is a diagram illustrating a second example of the position estimation of an erroneous word by the position estimation unit 183. FIG. 5 illustrates an example of a case where the position estimation unit 183 performs position estimation of an erroneous word of a text “The model name is written on the sea surface or side surface of the main body of the personal computer.”. It is assumed that the position estimation unit 183 divides this text into tokens such as "The/model name/is/written/on/the sea surface/or/side surface/of/ the main body/of/the personal computer/.”.

The position estimation unit 183 calculates each score of C-ERR, C-C, W-C, and W-ERR for each divided token. For “sea surface”, the score of W-ERR is the largest, and the position estimation unit 183 labels it with W-ERR. On the other hand, the score of W-C is the largest for each token other than “sea surface”, and the position estimation unit 183 labels each token with W-C.

As a result, the position estimation unit 183 estimates “sea surface” as an erroneous word. Furthermore, the position estimation unit 183 calculates, as an error score, 0.81 that is a score of W-ERR of “sea surface” that is a score estimated as an erroneous word.

FIG. 6 is a diagram illustrating a third example of the position estimation of an erroneous word by the position estimation unit 183. FIG. 6 illustrates an example of a case where the position estimation unit 183 performs position estimation of an erroneous word of a text “It is necessary to deal with various risks in consideration of AI and rhythm.”. It is assumed that the position estimation unit 183 divides this text into tokens such as "It/is/necessary/to/deal/with/various/risks/in/consideration/of/AI/and/rhythm/.”.

The position estimation unit 183 calculates each score of C-ERR, C-C, W-C, and W-ERR for each divided token. For each token of “AI”, “and”, and “rhythm”, the score of C-ERR is the largest and the position estimation unit 183 labels them with C-ERR. On the other hand, the score of W-C is the largest for each other token, and the position estimation unit 183 labels them with W-C.

As a result, the position estimation unit 183 estimates “AI and rhythm” as an erroneous word. In addition, the position estimation unit 183 calculates 0.61 that is the score of C-ERR of “rhythm” that is the largest of the scores estimated as the erroneous word as the error score.

The candidate character generation unit 184 masks the token estimated as an erroneous word by the position estimation unit 183, and estimates a candidate word for the masked portion.

The candidate character generation unit 184 corresponds to an example of a candidate character generation means.

The candidate character generation unit 184 may perform masking and estimation of a candidate word using a known method of a Masked Language Model (MLM).

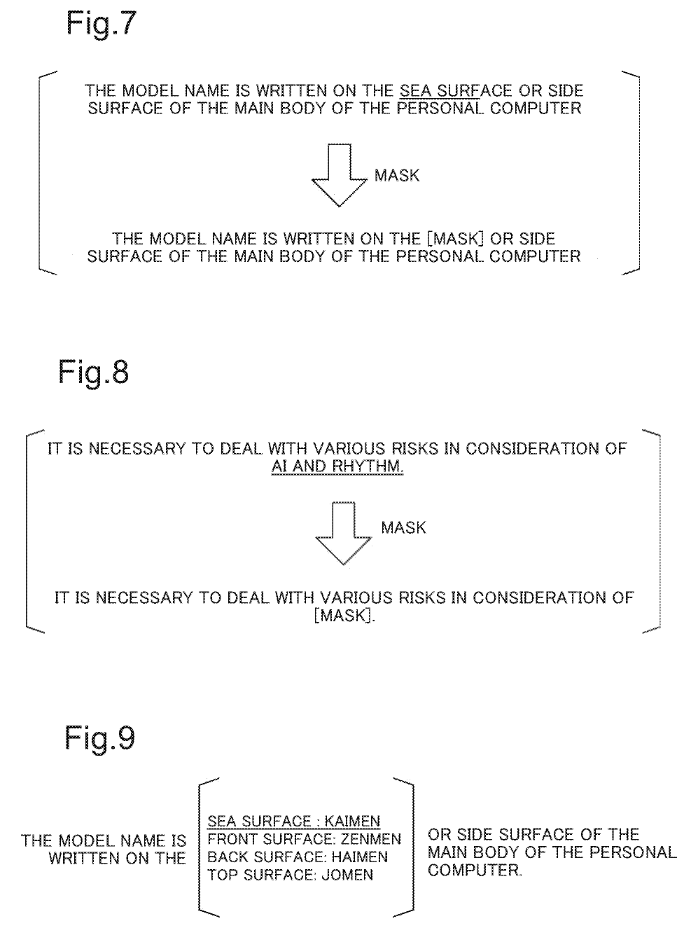

FIG. 7 is a diagram illustrating a first example of masking by the candidate character generation unit 184. FIG. 7 illustrates an example of a case where the candidate character generation unit 184 masks an erroneous word of a text “The model name is written on the sea surface or side surface of the main body of the personal computer.”.

Here, as in the example of FIG. 5, it is assumed that the position estimation unit 183 estimates “sea surface ” as an erroneous word. The candidate character generation unit 184 masks “sea surface” that is estimated to be an erroneous word.

Then, the candidate character generation unit 184 generates a word semantically applicable to the masked portion as a candidate word for the masked portion. For example, the candidate character generation unit 184 calculates a prediction score indicating a degree of semantic applicability to a masked portion for a word obtained using the language model, and selects a candidate word based on the prediction score. Here, it is assumed that the larger the prediction score, the more likely it is to apply to the masked portion.

The prediction score can be regarded as a score indicating the validity in context of the candidate word.

The candidate character generation unit 184 may generate a candidate character using a known method.

Furthermore, the candidate character generation unit 184 may select a word having a prediction score larger than a predetermined threshold value as a candidate word, or may select a predetermined number of words as candidate words in descending order of the prediction score. A set of candidate words generated for one erroneous word by the candidate character generation unit 184 is also referred to as a candidate word group.

For example, the candidate character generation unit 184 generates a list of candidate words as ['front surface', 'back surface', 'top surface',...] and calculates a list of prediction scores of each candidate word as [0.92, 0.90, 0.76,...].

FIG. 8 is a diagram illustrating a second example of masking by the candidate character generation unit 184. FIG. 8 illustrates an example of a case where the candidate character generation unit 184 masks an erroneous word of a text “It is necessary to deal with various risks in consideration of AI and rhythm.”.

Here, as in the example of FIG. 6, it is assumed that the position estimation unit 183 estimates “AI and rhythm” as an erroneous word. The candidate character generation unit 184 masks “AI and rhythm” that is estimated to be an erroneous word.

Then, the candidate character generation unit 184 generates a word semantically applicable to the masked portion as a candidate word for the masked portion.

For example, the candidate character generation unit 184 generates a list of candidate words as ['external factor', 'AI TRiSM', 'uncertainty',...] and calculates a list of prediction scores of each candidate word as [0.52, 0.46, 0.39,...].

The phonological similar expression calculation unit 185 gives a reading to the candidate word generated by the candidate character generation unit 184 and calculates a phonological similarity score indicating a phonological similarity (reading similarity) between the erroneous word and the candidate word.

The phonological similar expression calculation unit 185 corresponds to an example of a phonological similar expression calculation means.

The phonological similar expression calculation unit 185 performs a Kana change in consideration of the context for the input sentence.

That is, in a case where the meaning of the word varies depending on the reading, the phonological similar expression calculation unit 185 adopts the reading having a meaning that applies to the context.

The phonological similar expression calculation unit 185 replaces an erroneous word of the original input sentence with each candidate word, and performs Kana conversion in consideration of the context. That is, the phonological similar expression calculation unit 185 gives the reading of the candidate word in such a way as to apply to the context when the candidate word is applied to the portion masked by the position estimation unit 183.

The phonological similar expression calculation unit 185 may give reading to the candidate word using a known morphological analyzer. In a case where the candidate word is registered in the speech recognition dictionary but is not registered in the morphological analyzer, the phonological similar expression calculation unit 185 may use the reading registered in the speech recognition dictionary.

FIG. 9 is a diagram illustrating an example of giving reading to a candidate word by the phonological similar expression calculation unit 185. FIG. 9 illustrates an example of a case where reading is given to a candidate word of an erroneous word in the text “The model name is written on the sea surface or side surface of the main body of the personal computer.”.

As in the example of FIG. 5, it is assumed that the position estimation unit 183 estimates and masks the “sea surface” as an erroneous word, and the candidate character generation unit generates a list of candidate words of ['front surface', 'back surface', 'top surface',...]. The phonological similar expression calculation unit 185 gives a reading of “zenmen” to the “front surface”, a reading of “haimen” to the “back surface”, and a reading of “jomen” to “top surface”.

Then, the phonological similar expression calculation unit 185 calculates a phonological similarity score between the reading of the erroneous word and the reading given to the candidate word.

Here, it is assumed that the phonological similar expression calculation unit 185 uses the edit distance as the phonological similarity score. A score indicating greater phonological similarity the smaller the value, such as an edit distance, is also referred to as a phonological cost. However, the phonological similarity score used by the phonological similar expression calculation unit 185 is not limited to a specific one.

The phonological similar expression calculation unit 185 calculates the phonological cost of “zenmen” for “kaimen” as 2.

In addition, the phonological similar expression calculation unit 185 calculates the phonological cost of “haimen” for “kaimen” as 1.

Furthermore, the phonological similar expression calculation unit 185 calculates the phonological cost of “jomen” for “kaimen” as 3.

Then, the phonological similar expression calculation unit 185 generates a list of phonological costs of the candidate words as [2, 1, 3,...].

The classification unit 186 classifies the candidate words using the error score of the erroneous word and the prediction score and the phonological cost of the candidate word. In a case where there are a plurality of candidate words, the classification unit 186 classifies each of the candidate words.

The classification unit 186 corresponds to an example of a classification means.

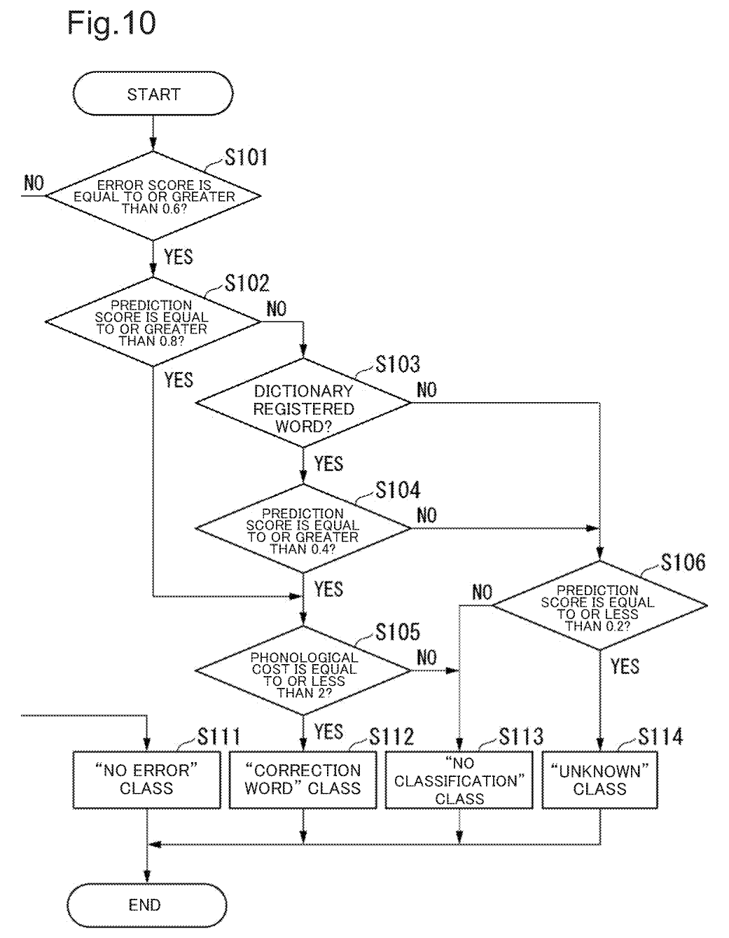

FIG. 10 is a diagram illustrating an example of a processing procedure of classifying candidate words by the classification unit 186.

### Step S101

The classification unit 186 determines whether the error score of the erroneous word is equal to or greater than 0.6.

In a case where the classification unit 186 determines that the error score is equal to or greater than 0.6 (step S101: YES), the processing proceeds to step S102.

On the other hand, in a case where the classification unit 186 determines that the error score is smaller than 0.6 (step S101: NO), the processing proceeds to step S111.

### Step S102

The classification unit 186 determines whether the prediction score of the candidate word is equal to or greater than 0.8.

In a case where the classification unit 186 determines that the prediction score is equal to or greater than 0.8 (step S102: YES), the processing proceeds to step S105.

On the other hand, in a case where the classification unit 186 determines that the prediction score is smaller than 0.8 (step S102: NO), the processing proceeds to step S103.

### Step S103

The classification unit 186 determines whether the candidate word is stored in the dictionary information storage unit 172.

In a case where the classification unit 186 determines that the candidate word is stored in the dictionary information storage unit 172 (step S103: YES), the processing proceeds to step S104.

On the other hand, in a case where the classification unit 186 determines that the candidate word is not stored in the dictionary information storage unit 172 (step S103: NO), the processing proceeds to step S106.

### Step S104

The classification unit 186 determines whether the prediction score of the candidate word is equal to or greater than 0.4.

In a case where the classification unit 186 determines that the prediction score is equal to or greater than 0.4 (step S104: YES), the processing proceeds to step S105.

On the other hand, in a case where the classification unit 186 determines that the prediction score is smaller than 0.4 (step S104: NO), the processing proceeds to step S106.

### Step S105

The classification unit 186 determines whether the phonological cost of the candidate word is equal to or less than 2.

In a case where the classification unit 186 determines that the phonological cost is equal to or less than 2 (step S105: YES), the processing proceeds to step S112.

On the other hand, in a case where the classification unit 186 determines that the phonological cost is greater than 2 (step S105: NO), the processing proceeds to step S113.

### Step S106

The classification unit 186 determines whether the prediction score of the candidate word is equal to or less than 0.2.

In a case where the classification unit 186 determines that the prediction score is equal to or less than 0.2 (step S106: YES), the processing proceeds to step S114.

On the other hand, in a case where the classification unit 186 determines that the prediction score is greater than 0.2 (step S106: NO), the processing proceeds to step S114.

### Step S111

The classification unit 186 classifies the candidate word into the “no error” class. In the case of the classification result of “no error” (classification into “no error” class), the correction device 100 treats a word estimated to be an erroneous word as a correct word (not an error).

After step S111, the classification unit 186 ends the processing of FIG. 10.

### Step S112

The classification unit 186 classifies the candidate word into the “correction word” class. The classification result of “correction word” (classification into “correction word” class) indicates that the candidate word can be used as the correction word. As described above, the correction word is a word to be replaced from the erroneous word.

After step S112, the classification unit 186 ends the processing of FIG. 10.

### Step S113

The classification unit 186 classifies the candidate word into “no classification” class. The classification result of “no classification” (classification into “no classification” class) is an intermediate classification result indicating that it cannot be determined whether the erroneous word is a recognition error of a word stored in the language model used by the classification unit 186 or a recognition error of a word not stored in the language model. If the erroneous word is the recognition error of the word that is stored in the dictionary information storage unit 172, it is indicated by the classification result of “correction word”. The recognition error of the word that is not stored in the dictionary information storage unit 172 is indicated by the classification result of “unknown term” (classification into “unknown term” class).

After step S113, the classification unit 186 ends the processing of FIG. 10.

### Step S114

The classification unit 186 classifies the candidate word into the “unknown term” class. As described above, the classification result of “unknown term” indicates that the erroneous word is due to a recognition error of a word that is not stored in the language model used by the classification unit 186.

After step S114, the classification unit 186 ends the processing of FIG. 10.

The numerical values illustrated in FIG. 10 are examples, and these are not the sole case.

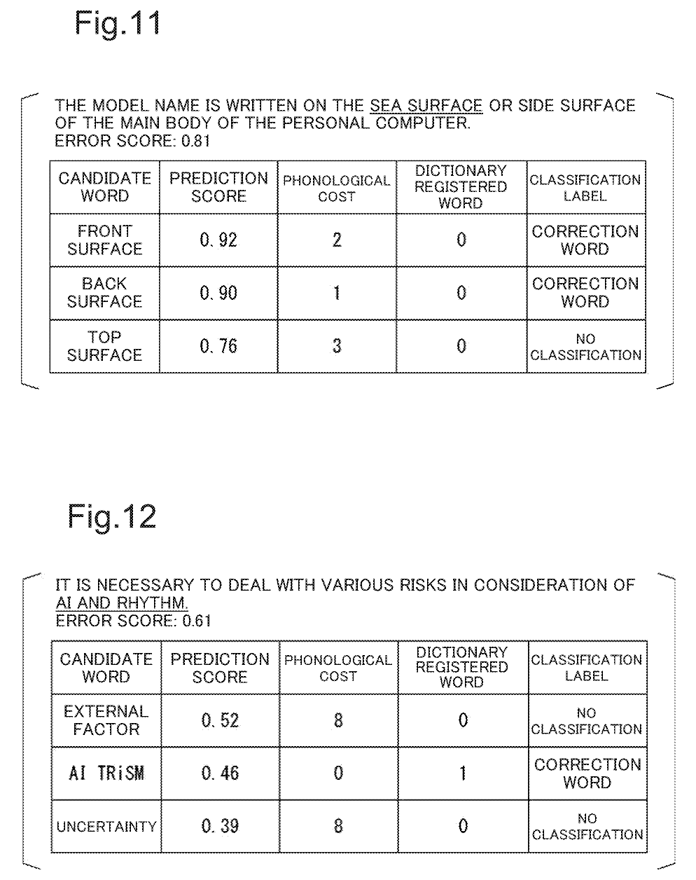

FIG. 11 is a diagram illustrating a first example of classification of candidate words by the classification unit 186. FIG. 11 illustrates an example of a case where the text is “The model name is written on the sea surface or side surface of the main body of the personal computer”.

As in the example of FIG. 5, it is assumed that the position estimation unit 183 estimates “sea surface” as an erroneous word, and calculates an error score as 0.81.

It is also assumed that the candidate character generation unit 184 generates “front surface”, “back surface”, and “top surface” as candidate words. In addition, it is assumed that the candidate character generation unit 184 calculates the prediction score of “front surface” as 0.92 and the phonological cost as 2. Furthermore, it is assumed that the candidate character generation unit 184 calculates the prediction score of “back surface” as 0.90 and the phonological cost as 1. Furthermore, it is assumed that the candidate character generation unit 184 calculates the prediction score of “top surface” as 0.76 and the phonological cost as 3.

The classification unit 186 performs the processing of FIG. 10 for each candidate word to classify the “front surface” and the “back surface” into “correction word” and to classify the “top surface” into “no classification”.

FIG. 12 is a diagram illustrating a second example of classification of candidate words by the classification unit 186. FIG. 12 illustrates an example of a case where the text is “It is necessary to deal with various risks in consideration of AI and rhythm.”.

As in the example of FIG. 6, it is assumed that the position estimation unit 183 estimates “AI and rhythm” as an erroneous word and calculates an error score as 0.61.

In addition, it is assumed that the candidate character generation unit 184 generates “external factor”, “AI TRiSM”, and “uncertainty” as candidate words. In addition, it is assumed that the candidate character generation unit 184 calculates the prediction score of “external factor” as 0.52 and the phonological cost as 8. Furthermore, it is assumed that the candidate character generation unit 184 calculates the prediction score of “AI TRiSM” as 0.46 and the phonological cost as 0. Furthermore, it is assumed that the candidate character generation unit 184 calculates the prediction score of “uncertainty” as 0.39 and the phonological cost as 8.

The classification unit 186 performs the processing of FIG. 10 for each candidate word to classify the “AI TRiSM” into “correction word” and to classify the “external factor” and the “uncertainty” as “no classification”.

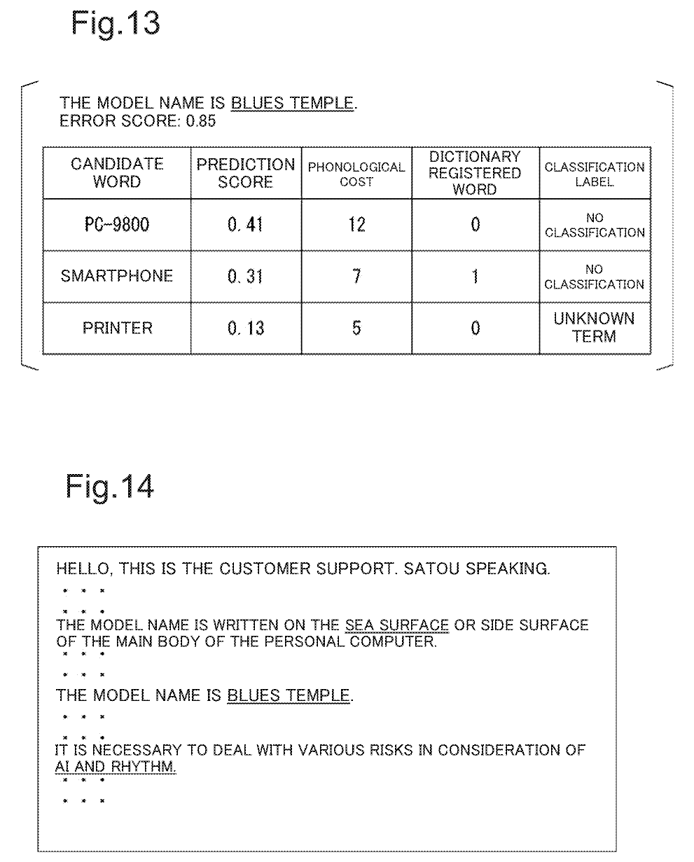

FIG. 13 is a diagram illustrating a third example of classification of candidate words by the classification unit 186. FIG. 13 illustrates an example of a case where the text is “The model name is Blues temple.”.

It is assumed that the position estimation unit 183 estimates “Blues temple” as an erroneous word and calculates an error score as 0.85.

It is also assumed that the candidate character generation unit 184 generates “PC-9800”, “smartphone”, and “printer” as candidate words. In addition, it is assumed that the candidate character generation unit 184 calculates the prediction score of “PC-9800” as 0.41 and the phonological cost as 12. Furthermore, it is assumed that the candidate character generation unit 184 calculates the prediction score of “smartphone” as 0.31 and the phonological cost as 7. Furthermore, it is assumed that the candidate character generation unit 184 calculates the prediction score of “printer” as 0.13 and the phonological cost as 5.

The classification unit 186 performs the processing of FIG. 10 for each candidate word to classify “printer” into “unknown term” and classify “PC-9800” and “smartphone” into “no classification”.

The revision unit 187 revises the erroneous word based on the classification result of the candidate word. The revision unit 187 corresponds to an example of a revision means.

The revision unit 187 may revise an erroneous word on a rule basis according to the following rules.

In a case where there are a plurality of candidate words classified as the “correction word” in the candidate word group, the candidate word having the smallest phonological cost is selected and replaced with the original word (erroneous word) as the correction word.

In a case where if at least one candidate word classified as the “correction word” exists in the candidate word group, the original word is replaced with the candidate word as the correction word.

In a case where there is no candidate word classified as the “correction word” and there is a candidate word registered in the “unknown term” in the candidate word group, the original word is determined as the unknown term.

Detecting that there are one or more candidate words classified as the “correction word” can be regarded as detecting a recognition error of a word that is registered in the dictionary.

Detecting that there is no candidate word classified as the “correction word” and there is a candidate word registered in the “unknown term” can be regarded as detecting a recognition error of a word that is not registered in the dictionary.

The processing performed by the revision unit 187 corresponds to one processing combining the processing of detecting a recognition error of a word that is not registered in the dictionary and the processing of detecting a recognition error of a word that is registered in the dictionary.

For example, in the case of the example of FIG. 11, the revision unit 187 selects, as the correction word, “back surface” having a small phonological cost of the “front surface” and the “back surface” classified as the “correction word”. Then, the revision unit 187 applies the correction word to the mask in which the erroneous word is masked by the position estimation unit 183.

As a result, the revision unit 187 corrects the text before correction: “The model name is written on the sea surface or side surface of the main body of the personal computer.” to the text after correction: “The model name is written on the back surface or side surface of the main body of the personal computer”.

Furthermore, in the case of the example of FIG. 12, the revision unit 187 selects “AI TRiSM” classified as the “correction word” as the correction word. Then, the revision unit 187 applies the correction word to the mask in which the erroneous word is masked by the position estimation unit 183.

As a result, the revision unit 187 corrects the text before correction: “It is necessary to deal with various risks in consideration of AI and rhythm.” to the text after correction: “It is necessary to deal with various risks in consideration of AI TRiSM”.

Furthermore, in the case of the example of FIG. 13, the revision unit 187 determines that “Blues temple” estimated to be an erroneous word is (a recognition error of) an unknown term. In this case, the revision unit 187 applies the reading of the erroneous word to the mask in which the erroneous word is masked by the position estimation unit 183.

As a result, the revision unit 187 corrects the text before correction: “The model name is Blues temple.” to the text after correction: “The model name is blue stella”.

The classification of the candidate word used by the revision unit to revise the erroneous word is also referred to as classification of the erroneous word. For example, in the case of the example of FIG. 11, the revision unit 187 sets the classification of the erroneous word as “correction word”. In the case of the example of FIG. 12 as well, the revision unit 187 sets the classification of the erroneous word as “correction word”. On the other hand, in the case of the example of FIG. 13, the revision unit 187 sets the classification of the erroneous word as “unknown term”.

The revision unit 187 outputs the text after the correction to the output processing unit 188 while indicating the corrected portion and the classification of the erroneous word.

The revision unit 187 may store the correction word (candidate word replaced from the erroneous word classified as “correction word”) in the correction term storage unit 173. Furthermore, the revision unit 187 may store an unknown term (reading of erroneous word replaced from the erroneous word classified as “unknown term”) in the unknown term storage unit 171. In this case, the output processing unit 188 may read out the correction term from the correction term storage unit 173. Furthermore, the output processing unit 188 may read out the unknown term from the unknown term storage unit 171.

The output processing unit 188 presents the text after the correction by the revision unit 187 to the user by causing the display unit 120 to display the text. At that time, the output processing unit 188 causes the display unit 120 to display the corrected portion and the classification of the erroneous word.

The output processing unit 188 corresponds to an example of an output processing means.

FIG. 14 is a diagram illustrating an example of a display of a text before correction by the display unit 120. In the example of FIG. 14, the display unit 120 displays the text before correction by underlining the erroneous word.

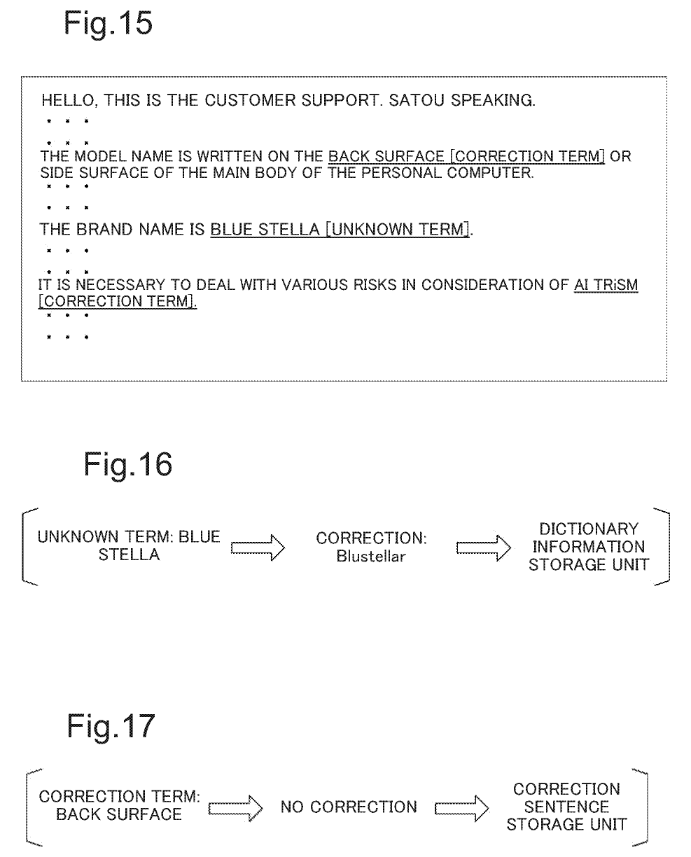

FIG. 15 is a diagram illustrating an example of a display of a text after correction by the display unit 120. In the example of FIG. 15, the display unit 120 underlines the corrected portion of the text and displays “[correction term]” or “[unknown term]” as the classification of the erroneous word for each corrected portion.

The user correction processing unit 189 accepts user's correction for the correction result of the text by the revision unit.

The user correction processing unit 189 corresponds to an example of a user correction processing means.

For example, in a state where the display unit 120 displays the text after correction, the user selects the corrected portion using the mouse of the operation input unit 130. Then, the user inputs a correct word for the selected corrected portion using the keyboard of the operation input unit 130. Alternatively, the user inputs that there is no correction for the selected corrected portion.

For example, in response to the corrected portion being selected, the display unit 120 displays a display region of a correct word input by the user, an operation button indicating that the input of the correct word is completed, and an operation button indicating that there is no correction in a pop-up window.

Upon completing the input of the correct word using the keyboard, the user clicks the operation button indicating that the input of the correct word is completed with the mouse. If there is no correction, the user clicks the operation button indicating that there is no correction with the mouse.

The display unit 120 is expected to assist the user in the correction by displaying the classification of the erroneous word for each corrected portion as in the example of FIG. 15. For example, it is expected that the user can be prompted to input a correct word by having the display unit 120 display “[unknown term]”.

In a case where all the candidate words are classified into the “no classification” class in the classification of candidate words by the classification unit 186, the display unit 120 may display “[no classification]” separately from “[correction term]” and “[unknown term]”. In this case, for example, as in the case where there is a candidate word classified into the “correction word” class, the revision unit 187 may perform correction to replace the erroneous word with the candidate word, and the display unit 120 may display the candidate word and “[no classification]”.

As a result, it is possible to notify the user that the candidate word is presented but the possibility that the candidate word is an unknown term is relatively high.

The user correction processing unit 189 stores a correction result of the unknown term by the user in the dictionary information storage unit 172. In addition, the user correction processing unit 189 stores a correction result by the user for the correction term in the correction sentence storage unit 174.

FIG. 16 is a diagram illustrating a first example of processing performed by the user correction processing unit 189.

In the example of FIG. 16, the user corrects “blue stella” that is an unknown term to “BluStellar”. It is considered that the word assumed as an unknown term is not stored in the dictionary information storage unit 172. Therefore, the user correction processing unit 189 stores “BluStellar” of the correction result by the user in the dictionary information storage unit 172.

The user correction processing unit 189 stores a combination of the correction result by the user, the reading of the unknown term, and the text after the correction in the dictionary information storage unit 172. The text after the correction can be used as an example sentence of a word to be registered.

FIG. 17 is a diagram illustrating a second example of processing performed by the user correction processing unit 189.

In the example of FIG. 17, the user does not correct the “back surface” that is the correction term. In a case where there is no user's correction on the correction term, the user correction processing unit 189 stores a combination of the correction term by the revision unit 187, the text before the correction, and the text after the correction in the correction sentence storage unit 174.

In the case of the example of FIG. 17, the user correction processing unit 189 stores, in the correction sentence storage unit 174, a combination of the “back surface” that is a correction term by the revision unit 187, “The model name is written on the sea surface or side surface of the main body of the personal computer.” that is a text before the correction, and “The model name is written on the back surface or side surface of the main body of the personal computer.” that is a text after the correction.

The data stored in the correction sentence storage unit 174 can be used for training of the speech recognition model (learning of the speech recognition model).

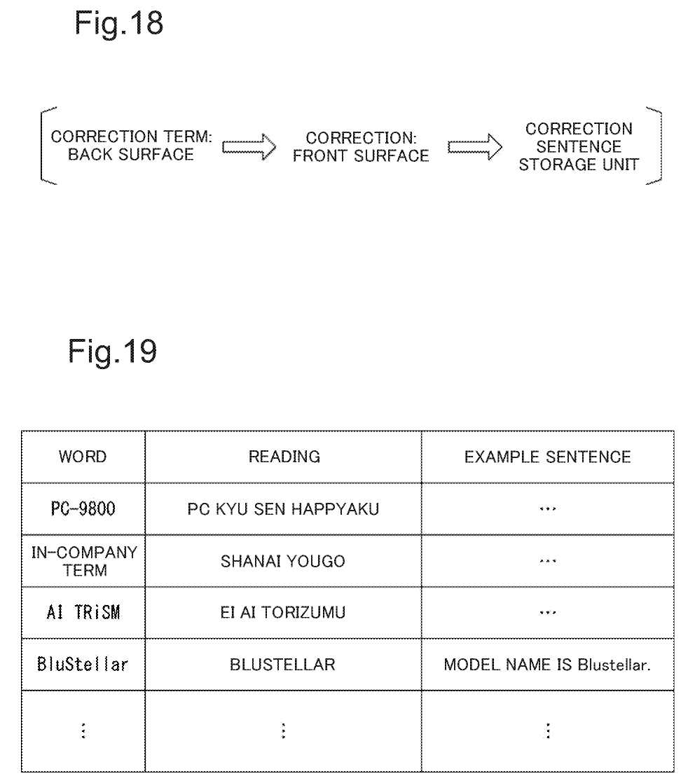

FIG. 18 is a diagram illustrating a third example of processing performed by the user correction processing unit 189.

In the example of FIG. 18, the user corrects the “back surface” that is a correction term to the “front surface”.

In a case where the user corrects the correction term, the user correction processing unit 189 stores a combination of the word after the correction by the user, the text before the correction, and the text after the correction in the correction sentence storage unit 174.

In the case of the example of FIG. 18, the user correction processing unit 189 stores, in the correction sentence storage unit 174, a combination of the “front surface” that is a word after the correction by the user, “The model name is written on the sea surface or side surface of the main body of the personal computer.” that is a text before the correction, and “The model name is written on the front surface or side surface of the main body of the personal computer.” that is a text after the correction.

FIG. 19 is a diagram illustrating an example of a data structure of dictionary information stored in the dictionary information storage unit 172. In the example of FIG. 19, the dictionary information storage unit 172 stores a word, a reading of the word, and an example sentence of the word. The dictionary information storage unit 172 may further store the distributed representation generated by the dictionary information addition unit 182.

The word and the reading stored in the dictionary information storage unit 172 may be synchronized with the speech recognition dictionary used by the speech recognition unit 181. For example, the processing unit 180 may synchronize the dictionary information storage unit 172 with the speech recognition dictionary.

The dictionary information stored in the dictionary information storage unit 172 may be used as training data (learning data) for updating the language model used by the position estimation unit 183 and the candidate character generation unit 184.

By using the dictionary information stored in the dictionary information storage unit 172 to update the language model used by the position estimation unit 183, it is expected that the position estimation unit 183 can easily extract the word indicated in the dictionary information from the speech text as the token.

By using the dictionary information stored in the dictionary information storage unit 172 to update the language model used by the candidate character generation unit 184, it is expected that the accuracy with which the candidate character generation unit 184 selects the word indicated in the dictionary information as the candidate word according to the context of the speech text is improved.

The dictionary information storage unit 172 may also be used as the unknown term storage unit 171. For example, the revision unit 187 may cause the dictionary information storage unit 172 to store the reading of the erroneous word estimated as the unknown term as a word and its reading and may cause the dictionary information storage unit 172 to store, as an example sentence, a text in which the reading is replaced from the erroneous word to the unknown term. Then, the user correction processing unit 189 may correct the information stored in the dictionary information storage unit 172 according to the correction by the user.

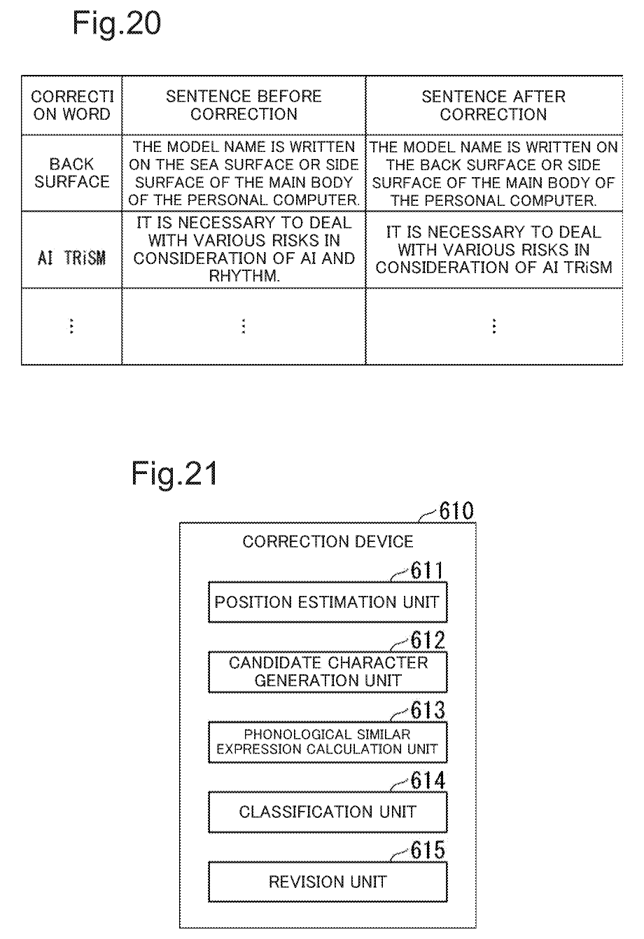

FIG. 20 is a diagram illustrating an example of a structure of data stored in the correction sentence storage unit 174. The information stored in the correction sentence storage unit 174 is also referred to as correction sentence information.

In the example of FIG. 20, the correction sentence storage unit 174 stores a correction word, a sentence before being corrected using the correction word, and a sentence after being corrected using the correction term.

The sentence before the correction and the sentence after the correction stored in the correction sentence storage unit 174 have a possibility of being useful data for learning of the speech recognition model (training of the speech recognition model). The sentence before the correction can be used as an example of a sentence including an error. The sentence after the correction can be used as an example of a correct sentence (correctly speech recognized sentence). Therefore, the correction sentence information stored in the correction sentence storage unit 174 may be used as training data (learning data) of update of the speech recognition model used by the speech recognition unit 181.

The correction sentence storage unit 174 may also be used as the correction term storage unit 173. For example, in a case where the revision unit 187 estimates an erroneous word as a correction term (i.e., in a case where it is estimated that there is a candidate word to be replaced from the erroneous word), a candidate word used for correction of the erroneous word, a sentence before the correction, and a sentence after the correction may be stored in the correction sentence storage unit 174. Then, the user correction processing unit 189 may correct the sentence information stored in the correction sentence storage unit 174 according to the correction by the user.

As described above, the position estimation unit 183 estimates the presence or absence of an erroneous word that is a portion having a possibility of being an error in the speech text obtained by the speech recognition, and the position of the erroneous word in a case where it is estimated that there is an erroneous word.

The candidate character generation unit 184 generates a candidate word that is a candidate for a word to be replaced from the erroneous word, and calculates a prediction score indicating the validity in context for each generated candidate word.

The phonological similar expression calculation unit 185 calculates a phonological similarity score indicating a phonological similarity with an erroneous word for each candidate word.

Using the prediction score and the phonological similarity score, the classification unit 186 classifies the candidate word into one of the classes including a correction word class that is a class indicating that the candidate word is a candidate to be replaced from the erroneous word, and an unknown term class that is a class indicating a possibility that there is no candidate word to be replaced from the erroneous word.

The revision unit 187 determines whether to replace the erroneous word with the candidate word or replace the erroneous word with the reading of the erroneous word based on the classification result of the candidate word, and corrects the speech text according to the determination.

According to the correction device 100, both the recognition error of the word that is not registered in the dictionary and the recognition error of the word that is registered in the dictionary are performed based on the classification result obtained by classifying the candidate words, so that the processing of detecting the recognition error of the word that is not registered in the dictionary and the processing of detecting the recognition error of the word that is registered in the dictionary can be performed as one processing combining the two. In this respect, the correction device 100 can efficiently detect the speech recognition error.

Furthermore, according to the correction device 100, even in a case where the unknown term is uttered only once, the unknown term can be detected.

In addition, the revision unit 187 determines to replace the erroneous word with any of the candidate words classified into the correction word class in a case where there is a candidate word classified into the correction word class, and determines to replace the erroneous word with the reading of the erroneous word in a case where there is no word classified into the correction word class and there is a candidate word classified into the unknown term class.

According to the correction device 100, by inputting the classification result of the candidate word into a simple rule, a recognition error of a word that is not registered in the dictionary and a recognition error of a word that is registered in the dictionary can be detected in a distinguished manner, and the error can be corrected according to the detection result.

According to the correction device 100, in this respect, the calculation load of the detection of the speech recognition error is small.

In addition to the correction word class and the unknown term class, the classification unit 186 classifies the candidate word into one of the classes including a no classification class that is an intermediate class between the correction word class and the unknown term class.

As a result, the flexibility of the processing performed by the correction device 100 can be enhanced. For example, in a case where all the candidate words are classified into [no classification], the display unit 120 may display “[no classification]” in the relevant portion in the display of the speech text after the correction.

In addition, the position estimation unit 183 calculates a score of an error for each token that is a group of character strings obtained by dividing the speech text and a score of an error of a plurality of consecutive tokens, and detects both an erroneous word due to a speech recognition error of each token and an erroneous word due to a speech recognition error of a plurality of consecutive tokens.

For any of an erroneous word due to a speech recognition error of each token and an erroneous word due to a speech recognition error of a plurality of consecutive tokens, the candidate character generation means generates a candidate word to be replaced from the erroneous word.

According to the correction device 100, it is possible to perform correction of replacing a plurality of consecutive tokens with one word. This correction cannot be performed only by the correction of replacing the word of each token.

In addition, the output processing unit 188 presents, to the user, the speech text after the correction while indicating the corrected portion, and the distinction between a corrected portion in which the erroneous word is replaced with the candidate word or a corrected portion in which the erroneous word is replaced with the reading of the erroneous word.

The user correction processing unit 189 accepts user's correction for correction in the presented speech text.

According to the correction device 100, the presentation of the distinction of the corrected portions is expected to assist the user in the correction. For example, as in the example of FIG. 15, by having the display unit 120 display the “[unknown term]”, it is expected to prompt the user to input a correct word.

In addition, a correction result of the speech text when determined that there is a candidate word to be replaced from the erroneous word is used as training data of a speech recognition model used for speech recognition.

The correction result of the speech text when determined that there is a candidate word to be replaced from the erroneous word is expected to be effective in training the speech recognition model. According to the correction device 100, it is expected that the accuracy of the speech recognition model can be improved in this respect.

In addition, the correction result of the speech text when determined that there is no candidate word to be replaced from the erroneous word is used as the training data of the language model used by the position estimation unit 183.

According to the correction device 100, it is expected that the position estimation unit 183 can easily calculate a small error score (can easily detect that there is no speech recognition error) even for the word newly stored in the dictionary information storage unit 172.

In addition, the correction result of the speech text when determined that there is no candidate word to be replaced from the erroneous word is used as the training data of the language model used by the candidate character generation means.

According to the correction device 100, even for the word newly stored in the dictionary information storage unit 172, it is expected that the possibility that the candidate character generation unit 184 can present the newly stored word as a candidate word is increased.

### Second Example Embodiment

FIG. 21 is a diagram illustrating an example of a configuration of a correction device according to at least one example embodiment. In the configuration illustrated in FIG. 21, a correction device 610 includes a position estimation unit 611, a candidate character generation unit 612, a phonological similar expression calculation unit 613, a classification unit 614, and a revision unit 615.

With this configuration, the position estimation unit 611 estimates the presence or absence of an erroneous word that is a portion having a possibility of an error in the speech text obtained by speech recognition, and the position of the erroneous word in a case where it is estimated that there is an erroneous word.

The candidate character generation unit 612 generates a candidate word that is a candidate for a word to be replaced from the erroneous word, and calculates a prediction score indicating the validity in context for each generated candidate word.

The phonological similar expression calculation unit 613 calculates a phonological similarity score indicating a phonological similarity with an erroneous word for each candidate word.

Using the prediction score and the phonological similarity score, the classification unit 614 classifies the candidate word into one of the classes including a correction word class that is a class indicating that the candidate word is a candidate to be replaced from the erroneous word, and an unknown term class that is a class indicating a possibility that there is no candidate word to be replaced from the erroneous word.

The revision unit 615 determines whether to replace the erroneous word with the candidate word or replace the erroneous word with the reading of the erroneous word based on the classification result of the candidate word, and corrects the speech text according to the determination.

The position estimation unit 611 corresponds to an example of a position estimation means. The candidate character generation unit 612 corresponds to an example of a candidate character generation means. The phonological similar expression calculation unit 613 corresponds to an example of a phonological similar expression calculation means. The classification unit 614 corresponds to an example of a classification means. The revision unit 615 corresponds to an example of a revision means.

According to the correction device 610, both the recognition error of the word that is not registered in the dictionary and the recognition error of the word that is registered in the dictionary are detected based on the classification result obtained by classifying the candidate words, so that the processing of detecting the recognition error of the word that is not registered in the dictionary and the processing of detecting the recognition error of the word that is registered in the dictionary can be performed as one processing combining the two. In this respect, the correction device 610 can efficiently detect the speech recognition error.

Furthermore, according to the correction device 610, even in a case where the unknown term is uttered only once, the unknown term can be detected.

### Third Example Embodiment

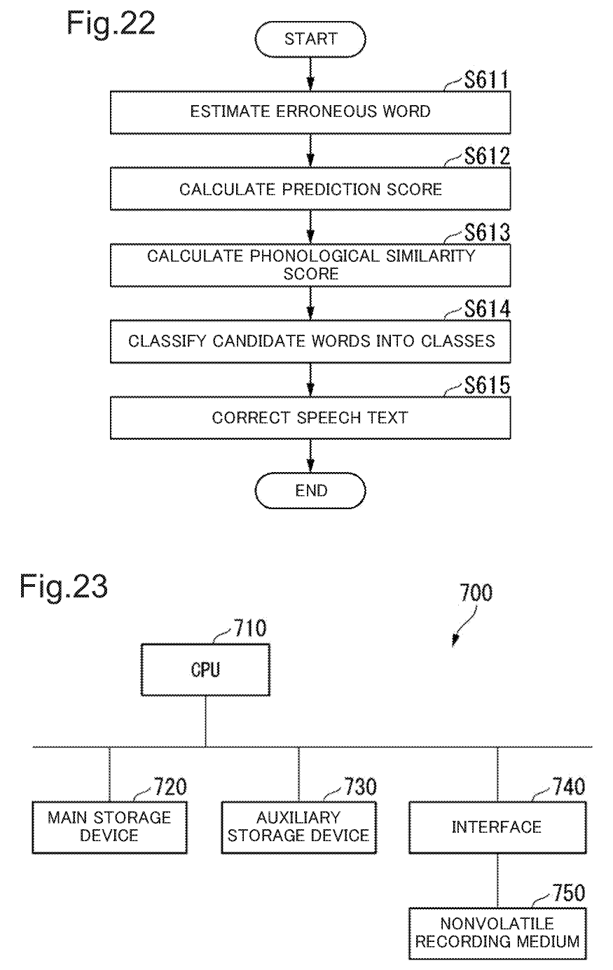

FIG. 22 is a diagram illustrating an example of a procedure of processing in the correction method according to at least one example embodiment. The correction method shown in FIG. 22 includes estimating an erroneous word (step S611), calculating a prediction score (step S612), calculating a phonological similarity score (step S613), classifying candidate words into classes (step S614), and correcting a speech text (step S615).

In estimating an erroneous word (step S611), the computer estimates the presence or absence of an erroneous word that is a portion having a possibility of an error in the speech text obtained by speech recognition, and the position of the erroneous word in a case where it is estimated that there is an erroneous word.

In calculating the prediction score (step S612), the computer generates a candidate word that is a candidate for a word to be replaced from the erroneous word, and calculates a prediction score indicating the validity in context for each generated candidate word.

In calculating the phonological similarity score (step S613), the computer calculates the phonological similarity score indicating the phonological similarity with the erroneous word for each candidate word.

In classifying candidate words into classes (step S614), the computer classifies the candidate words into one of the classes including a correction word class that is a class indicating that the candidate word is a candidate to be replaced from an erroneous word and an unknown term class that is a class indicating that there is no candidate word to be replaced from the erroneous word by using the prediction score and the phonological similarity score.

In correcting the speech text (step S615), the computer determines whether to replace the erroneous word with the candidate word or replace the erroneous word with the reading of the erroneous word from the erroneous word based on the classification result of the candidate word, and corrects the speech text according to the determination.

According to the correction method illustrated in FIG. 22, both the recognition error of the word that is not registered in the dictionary and the recognition error of the word that is registered in the dictionary are performed based on the classification result obtained by classifying the candidate words, so that the processing of detecting the recognition error of the word that is not registered in the dictionary and the processing of detecting the recognition error of the word that is registered in the dictionary can be performed as one processing combining the two. According to the correction method illustrated in FIG. 22, the speech recognition error can be efficiently detected in this respect.

Furthermore, according to the correction method illustrated in FIG. 22, even in a case where the unknown term is uttered only once, the unknown term can be detected.

FIG. 23 is a diagram illustrating an example of a configuration of a computer according to at least one example embodiment.

In the configuration illustrated in FIG. 23, a computer 700 includes a CPU 710, a main storage device 720, an auxiliary storage device 730, an interface 740, and a nonvolatile recording medium 750.

Any one or more of the correction device 100 and the correction device 610 or a part thereof may be mounted on the computer 700. In this case, the operation of each processing unit described above is stored in the auxiliary storage device 730 in the form of a program. The CPU 710 reads the program from the auxiliary storage device 730, loads the program in the main storage device 720, and executes the above processing according to the program. Furthermore, the CPU 710 secures a storage area related to each of the above-described storage units in the main storage device 720 according to the program. Communication between each device and another device is executed by the interface 740 having a communication function and performing communication under the control of the CPU 710. The interface 740 has a port for the nonvolatile recording medium 750 and reads information from the nonvolatile recording medium 750 and writes information to the nonvolatile recording medium 750.

In a case where the correction device 100 is mounted in the computer 700, the operation of the processing unit 180 and each unit thereof is stored in the auxiliary storage device 730 in the form of a program. The CPU 710 reads the program from the auxiliary storage device 730, loads the program in the main storage device 720, and executes the above processing according to the program.

The CPU 710 secures a storage area for the storage unit 170 in the main storage device 720 according to the program. Communication with another device by the communication unit 110 is executed by the operation of the interface 740 having a communication function under the control of the CPU 710. The display of the image by the display unit 120 is executed by the interface 740 including a display device and displaying various images under the control of the CPU 710. The acceptance of user operation by the operation input unit 130 is executed by the interface 740 including an input device and accepting the user operation under the control of the CPU 710.

In a case where the correction device 610 is mounted on the computer 700, the operations of the position estimation unit 611, the candidate character generation unit 612, the phonological similar expression calculation unit 613, the classification unit 614, and the revision unit 615 are stored in the auxiliary storage device 730 in the form of a program. The CPU 710 reads the program from the auxiliary storage device 730, loads the program in the main storage device 720, and executes the above processing according to the program.

In addition, the CPU 710 secures a storage area for the correction device 610 to perform processing in the main storage device 720 according to the program. Communication between the correction device 610 and another device is executed by allowing the interface 740 having a communication function to be operated under the control of the CPU 710.

The interaction between the correction device 610 and the user is executed by the interface 740 including an input device and an output device, information being presented to the user by the output device according to the control of the CPU 710, and a user operation being accepted by the input device.

Any one or more of the above-described programs may be recorded in the nonvolatile recording medium 750. In this case, the interface 740 may read the program from the nonvolatile recording medium 750. The CPU 710 may directly execute the program read by the interface 740 or may temporarily save the program in the main storage device 720 or the auxiliary storage device 730 and execute the program.

A program for executing all or part of the processing performed by the correction device 100 and the correction device 610 may be recorded in a computer-readable recording medium, and the processing of each unit may be performed by causing a computer system to read and execute the program recorded in the recording medium. The “computer system” herein includes an Operating System (OS) and hardware such as peripheral devices.

The “computer-readable recording medium” refers to a portable medium such as a flexible disk, a magneto-optical disk, a Read Only Memory (ROM), and a Compact Disc Read Only Memory (CD-ROM), and a storage device such as a hard disk built in a computer system. The program may be for implementing some of the functions described above, and the functions described above may be implemented in combination with a program already recorded in the computer system.

While the present disclosure has been particularly shown and described with reference to example embodiments thereof, the present disclosure is not limited to these example embodiments. It will be understood by those of ordinary skill in the art that various changes in form and details may be made therein without departing from the spirit and scope of the present disclosure as defined by the claims. And each example embodiment can be appropriately combined with other example embodiments.

Some or all of the above-described example embodiments may be described as the following supplementary notes, but are not limited to the following supplementary notes.

### Supplementary Note 1

A correction device including

a position estimation means for estimating presence or absence of an erroneous word that is a portion having a possibility of an error in a speech text obtained by speech recognition, and a position of an erroneous word in a case where it is estimated that there is an erroneous word,

a candidate character generation means for generating a candidate word that is a candidate for a word to be replaced from the erroneous word, and calculating a prediction score indicating validity in context for each generated candidate word,

a phonological similar expression calculation means for calculating a phonological similarity score indicating a phonological similarity with the erroneous word for each candidate word,

a classification means for classifying the candidate word into one of the classes including a correction word class that is a class indicating that the candidate word is a candidate to be replaced from the erroneous word and an unknown term class that is a class indicating a possibility that there is no candidate word to be replaced from the erroneous word by using the prediction score and the phonological similarity score, and

a correction means for determining, based on a classification result of the candidate word, whether to replace the erroneous word with the candidate word or replace the erroneous word with reading of the erroneous word, and correcting the speech text according to the determination.

### Supplementary Note 2

The correction device according to supplementary note 1, in which

the correction means determines to replace the erroneous word with any of the candidate words classified into the correction word class in a case where there are candidate words classified into the correction word class, and determines to replace the erroneous word with reading of the erroneous word in a case where there are no candidate words classified into the correction word class and there are candidate words classified into the unknown term class.

### Supplementary Note 3

The correction device according to supplementary note 1 or 2, in which

the classification means classifies the candidate word into one of the classes including a no classification class that is an intermediate class between the correction word class and the unknown term class, in addition to the correction word class and the unknown term class.

### Supplementary Note 4

The correction device according to any one of supplementary notes 1 to 3, in which

the position estimation means calculates a score of an error for each token that is a group of character strings obtained by dividing the speech text and a score of an error of a plurality of consecutive tokens, and detects both an erroneous word due to a speech recognition error of each token and an erroneous word due to a speech recognition error of a plurality of consecutive tokens, and

the candidate character generation means generates a candidate word to be replaced from an erroneous word for both of an erroneous word due to a speech recognition error of each token and an erroneous word due to a speech recognition error of a plurality of consecutive tokens.

### Supplementary Note 5

The correction device according to any one of supplementary notes 1 to 4, further including

an output processing means for presenting to a user, speech text after correction, while indicating a corrected portion and a distinction between a corrected portion in which an erroneous word is replaced with a candidate word or a corrected portion in which an erroneous word is replaced with a reading of the erroneous word, and

a user correction processing means for accepting user's correction for correction in the presented speech text.

### Supplementary Note 6

The correction device according to any one of supplementary notes 1 to 5, in which

a correction result of the speech text when determined that there is a candidate word to be replaced from the erroneous word is used as training data of a speech recognition model used for the speech recognition.

### Supplementary Note 7

The correction device according to any one of supplementary notes 1 to 6, in which

a correction result of the speech text when determined that there is no candidate word to be replaced from the erroneous word is used as training data of a language model used by the position estimation means.

### Supplementary Note 8

The correction device according to any one of supplementary notes 1 to 7, in which

a correction result of the speech text when determined that there is no candidate word to be replaced from the erroneous word is used as training data of a language model used by the candidate character generation means.

### Supplementary Note 9

A correction method including, by a computer,

estimating presence or absence of an erroneous word that is a portion having a possibility of an error in a speech text obtained by speech recognition, and a position of an erroneous word in a case where it is estimated that there is an erroneous word,

generating a candidate word that is a candidate for a word to be replaced from the erroneous word, and calculating a prediction score indicating validity in context for each generated candidate word,

calculating a phonological similarity score indicating a phonological similarity with the erroneous word for each candidate word,

classifying the candidate word into one of the classes including a correction word class that is a class indicating that the candidate word is a candidate to be replaced from the erroneous word and an unknown term class that is a class indicating a possibility that there is no candidate word to be replaced from the erroneous word by using the prediction score and the phonological similarity score, and

determining, based on a classification result of the candidate word, whether to replace the erroneous word with the candidate word or replace the erroneous word with reading of the erroneous word, and correcting the speech text according to the determination.

### Supplementary Note 10

The correction method according to supplementary note 9, in which

the correcting includes the computer to determine to replace the erroneous word with any of the candidate words classified into the correction word class in a case where there are candidate words classified into the correction word class, and determine to replace the erroneous word with reading of the erroneous word in a case where there are no candidate words classified into the correction word class and there are candidate words classified into the unknown term class.

### Supplementary Note 11

The correction method according to supplementary note 9 or 10, in which

the classifying includes the computer to classify the candidate word into one of the classes including a no classification class that is an intermediate class between the correction word class and the unknown term class, in addition to the correction word class and the unknown term class.

### Supplementary Note 12

The correction method according to any one of supplementary notes 9 to 11, in which

the estimating includes the computer to calculate a score of an error for each token that is a group of character strings obtained by dividing the speech text and a score of an error of a plurality of consecutive tokens, and detect both an erroneous word due to a speech recognition error of each token and an erroneous word due to a speech recognition error of a plurality of consecutive tokens, and

the calculating of the prediction score includes the computer to generate a candidate word to be replaced from an erroneous word for both of an erroneous word due to a speech recognition error of each token and an erroneous word due to a speech recognition error of a plurality of consecutive tokens.

### Supplementary Note 13

The correction method according to any one of supplementary notes 9 to 12, further including, by the computer,

presenting, to a user, speech text after correction, while indicating a corrected portion and a distinction between a corrected portion in which an erroneous word is replaced with a candidate word or a corrected portion in which an erroneous word is replaced with a reading of the erroneous word, and

accepting user's correction for correction in the presented speech text.

### Supplementary Note 14

The correction method according to any one of supplementary notes 9 to 13, in which

a correction result of the speech text when determined that there is a candidate word to be replaced from the erroneous word is used as training data of a speech recognition model used for the speech recognition.

### Supplementary Note 15

The correction method according to any one of supplementary notes 9 to 14, in which

a correction result of the speech text when determined that there is no candidate word to be replaced from the erroneous word is used as training data of a language model used by the estimating.

### Supplementary Note 16

The correction method according to any one of supplementary notes 9 to 15, in which

a correction result of the speech text when determined that there is no candidate word to be replaced from the erroneous word is used as training data of a language model used by calculating the prediction score.

### Supplementary Note 17

A program for causing a computer to execute

estimating presence or absence of an erroneous word that is a portion having a possibility of an error in a speech text obtained by speech recognition, and a position of an erroneous word in a case where it is estimated that there is an erroneous word,

generating a candidate word that is a candidate for a word to be replaced from the erroneous word, and calculating a prediction score indicating validity in context for each generated candidate word,

calculating a phonological similarity score indicating a phonological similarity with the erroneous word for each candidate word,

classifying the candidate word into one of the classes including a correction word class that is a class indicating that the candidate word is a candidate to be replaced from the erroneous word and an unknown term class that is a class indicating a possibility that there is no candidate word to be replaced from the erroneous word by using the prediction score and the phonological similarity score, and

determining, based on a classification result of the candidate word, whether to replace the erroneous word with the candidate word or replace the erroneous word with reading of the erroneous word, and correcting the speech text according to the determination.

### Supplementary Note 18

The program according to supplementary note 17, in which

the correcting includes causing the computer to execute determining to replace the erroneous word with any of the candidate words classified into the correction word class in a case where there are candidate words classified into the correction word class, and determining to replace the erroneous word with reading of the erroneous word in a case where there are no candidate words classified into the correction word class and there are candidate words classified into the unknown term class.

### Supplementary Note 19

The program according to supplementary note 17 or 18, in which

the classifying includes causing the computer to execute

classifying the candidate word into one of the classes including a no classification class that is an intermediate class between the correction word class and the unknown term class, in addition to the correction word class and the unknown term class.

### Supplementary Note 20

The program according to any one of supplementary notes 17 to 19, in which

the estimating includes causing the computer to execute calculating a score of an error for each token that is a group of character strings obtained by dividing the speech text and a score of an error of a plurality of consecutive tokens, and detecting both an erroneous word due to a speech recognition error of each token and an erroneous word due to a speech recognition error of a plurality of consecutive tokens, and

the calculating of the prediction score includes causing the computer to execute generating a candidate word to be replaced from an erroneous word for both of an erroneous word due to a speech recognition error of each token and an erroneous word due to a speech recognition error of a plurality of consecutive tokens.

### Supplementary Note 21

The program according to any one of supplementary notes 17 to 20, further causing the computer to execute,

presenting, to a user, speech text after correction, while indicating a corrected portion and a distinction between a corrected portion in which an erroneous word is replaced with a candidate word or a corrected portion in which an erroneous word is replaced with a reading of the erroneous word, and

accepting user's correction for correction in the presented speech text.

### Supplementary Note 22

The program according to any one of supplementary notes 17 to 21, in which

a correction result of the speech text when determined that there is a candidate word to be replaced from the erroneous word is used as training data of a speech recognition model used for the speech recognition.

### Supplementary Note 23

The program according to any one of supplementary notes 17 to 22, in which

a correction result of the speech text when determined that there is no candidate word to be replaced from the erroneous word is used as training data of a language model used by the estimating.

### Supplementary Note 24

The program according to any one of supplementary notes 17 to 23, in which

a correction result of the speech text when determined that there is no candidate word to be replaced from the erroneous word is used as training data of a language model used by calculating the prediction score.

According to an aspect of the present disclosure, processing of detecting a recognition error of a word that is not registered in the dictionary and processing of detecting a recognition error of a word that is registered in the dictionary can be performed as one processing combining both processing.

1. A correction device comprising:
at least one memory configured to store instructions; and
at least one processor configured to execute the instructions to:
estimate presence or absence of an erroneous word that is a portion having a possibility of an error in a speech text obtained by speech recognition, and a position of the erroneous word in a case where it is estimated that there is the erroneous word;
generate a candidate word that is a candidate for a word to be replaced from the erroneous word, and calculate a prediction score indicating validity in context for each generated candidate word;
calculate a phonological similarity score indicating a phonological similarity with the erroneous word for each candidate word;
classify the candidate word into one of the classes including a correction word class that is a class indicating that the candidate word is a candidate to be replaced from the erroneous word and an unknown term class that is a class indicating a possibility that there is no candidate word to be replaced from the erroneous word by using the prediction score and the phonological similarity score; and
determine, based on a classification result of the candidate word, whether to replace the erroneous word with the candidate word or replace the erroneous word with reading of the erroneous word, and correcting the speech text according to the determination.

2. The correction device according to claim 1, wherein the at least one processor is further configured to execute the instructions to:
determine to replace the erroneous word with any of the candidate words classified into the correction word class in a case where there are candidate words classified into the correction word class, and determine to replace the erroneous word with reading of the erroneous word in a case where there are no candidate words classified into the correction word class and there are candidate words classified into the unknown term class.

3. The correction device according to claim 1, wherein the at least one processor is further configured to execute the instructions to:
classify the candidate word into one of the classes including a no classification class that is an intermediate class between the correction word class and the unknown term class, in addition to the correction word class and the unknown term class.

4. The correction device according to claim 1, wherein the at least one processor is further configured to execute the instructions to:
calculate a score of an error for each token that is a group of character strings obtained by dividing the speech text and a score of an error of a plurality of consecutive tokens, and detect both an erroneous word due to a speech recognition error of each token and an erroneous word due to a speech recognition error of a plurality of consecutive tokens, and
generate a candidate word to be replaced from an erroneous word for both of an erroneous word due to a speech recognition error of each token and an erroneous word due to a speech recognition error of a plurality of consecutive tokens.

5. The correction device according to claim 1, wherein the at least one processor is further configured to execute the instructions to:
present to a user, speech text after correction, while indicating a corrected portion and a distinction between a corrected portion in which an erroneous word is replaced with a candidate word or a corrected portion in which an erroneous word is replaced with a reading of the erroneous word; and
accept user's correction for correction in the presented speech text.

6. The correction device according to claim 1, wherein
a correction result of the speech text when determined that there is a candidate word to be replaced from the erroneous word is used as training data of a speech recognition model used for the speech recognition.

7. The correction device according to claim 1, wherein
a correction result of the speech text when determined that there is no candidate word to be replaced from the erroneous word is used as training data of a language model used.

8. The correction device according to claim 1, wherein
a correction result of the speech text when determined that there is no candidate word to be replaced from the erroneous word is used as training data of a language model used.

9. The correction device according to claim 1, wherein the generating the one or more candidate words includes using a language model trained by machine learning to generate the one or more candidate words based on a context of the speech text obtained by the speech recognition.

10. The correction device according to claim 1, wherein the at least one processor is further configured to execute the instructions to:
cause a display to present the classification result for a corrected portion of the speech text obtained by the speech recognition to a user, to support the user's decision making on whether to accept or further modify the corrected portion.

11. A correction method comprising, by a computer:
estimating presence or absence of an erroneous word that is a portion having a possibility of an error in a speech text obtained by speech recognition, and a position of an erroneous word in a case where it is estimated that there is an erroneous word;
generating a candidate word that is a candidate for a word to be replaced from the erroneous word, and calculating a prediction score indicating validity in context for each generated candidate word;
calculating a phonological similarity score indicating a phonological similarity with the erroneous word for each candidate word;
classifying the candidate word into one of the classes including a correction word class that is a class indicating that the candidate word is a candidate to be replaced from the erroneous word and an unknown term class that is a class indicating a possibility that there is no candidate word to be replaced from the erroneous word by using the prediction score and the phonological similarity score; and
determining, based on a classification result of the candidate word, whether to replace the erroneous word with the candidate word or replace the erroneous word with reading of the erroneous word, and correcting the speech text according to the determination.

12. A non-transitory computer-readable recording medium recorded with a program for causing a computer to execute:
estimating presence or absence of an erroneous word that is a portion having a possibility of an error in a speech text obtained by speech recognition, and a position of an erroneous word in a case where it is estimated that there is an erroneous word;
generating a candidate word that is a candidate for a word to be replaced from the erroneous word, and calculating a prediction score indicating validity in context for each generated candidate word;
calculating a phonological similarity score indicating a phonological similarity with the erroneous word for each candidate word;
classifying the candidate word into one of the classes including a correction word class that is a class indicating that the candidate word is a candidate to be replaced from the erroneous word and an unknown term class that is a class indicating a possibility that there is no candidate word to be replaced from the erroneous word by using the prediction score and the phonological similarity score; and
determining, based on a classification result of the candidate word, whether to replace the erroneous word with the candidate word or replace the erroneous word with reading of the erroneous word, and correcting the speech text according to the determination.
